(19) United States
(12) Patent Application Publication
(10) Pub. No.: US 2004/0018479 A1
(43) Pub. Date: Jan. 29, 2004

(54) Computer implemented tutoring system

(76) Inventors: David E. Pritchard, Cambridge, MA (US); Alexander A. Pritchard, New York, NY (US); Adam Morton, Malden, MA (US); David A. Kokorowski, Somerville, MA (US); Elsa-Sofia Morote, Holstville, NY (US)

Correspondence Address: FISH & RICHARDSON PC, 225 FRANKLIN ST, BOSTON, MA, 02110, US

(21) Appl. No.: 10/325,800

(22) Filed: Dec. 19, 2002

Related U.S. Application Data
(60) Provisional application No. 60/344,123, filed on Dec. 21, 2001.

(51) Int. Cl. G09B 3/00

(52) U.S. Cl. 434/350; 434/362; 434/118

(57) ABSTRACT

A computer-implemented system, which is applicable to a variety of specific knowledge domains, conducts an interactive dialog with a student. The dialog helps the student arrive at a correct solution to a problem, for example by presenting problems in multiple parts, providing hints or simpler subparts to the student when requested or appropriate, and responding usefully to the student's wrong answers. The system interprets the nature of a student's errors to adapt the interaction to that student. For example, the system can select questions based on a detailed assessment of the student's knowledge. The questions can have a variety of types of answers, including freeform answer types, for example symbolic expressions. The system can include authoring tools to let teachers write problems, displays detailed information on how students interact with these problems, and allows teachers to address frequently given incorrect responses. The system can provide a skill rating of each student on a preselected list of topics, each of which might be an element of knowledge for example declarative, conceptual, or procedural knowledge.

### CROSS-REFERENCE TO RELATED APPLICATIONS

This application claims the benefit of U.S. Provisional Application No. 60/344,123, filed Dec. 21, 2001, which is incorporated herein in its entirety by reference.

### BACKGROUND

This invention relates to computer-implemented instruction.

Today's general computer implemented instruction systems are typically limited in the range of types of questions that are asked, and the tailoring of interactions to particular student's responses. For example, some systems make use of multiple-choice questions, which are easily scored by a computer. Questions may be presented in a scripted order, or may be selected based on which questions the student previously answered incorrectly.

### SUMMARY

In a general aspect, the invention is a computer-implemented system that is applicable to a variety of specific knowledge domains. The system conducts an interactive dialog with a student that helps the student arrive at a correct solution to a problem, for example by presenting problems in multiple parts, providing hints or simpler subparts to the student when requested or appropriate, and responding usefully to the student's wrong answers. The system interprets the nature of a student's errors to adapt the interaction to that student. For example, the system can select questions based on a detailed assessment of the student's knowledge. The questions can have a variety of types of answers, including freeform answer types, for example symbolic expressions. The system can include authoring tools to let teachers write problems, displays detailed information on how students interact with these problems, and allows teachers to address frequently given incorrect responses. The system can provide a skill rating of each student on a preselected list of topics, each of which might be an element of knowledge for example declarative, conceptual, or procedural knowledge.

In one aspect, in general, the invention features a method for computer aided tutoring that includes authoring a number of problems in a domain, administering the problems to one or more students, and maintaining an assessment of each of the students. Authoring each of at least some of the problems includes authoring a correct response and one or more incorrect responses to the problem. For each of at least some of the problems, the problem is associated with one or more skills in the domain. The assessment of each of the students includes a proficiency assessment for one or more skills in the domain, and maintaining the assessment includes updating a student's assessment based on a received response from that student to the problems and one or more skills associated with those problems.

The method can include one or more of the following features:

Administering the problems to students includes presenting the problems to the students, receiving responses to the problems from the students, and comparing each of the received responses to one or more authored responses for the problem.

For at least some of the problems the received response is compared to one or more incorrect responses authored for the problem.

For each of at least some of the authored incorrect responses to problems, those incorrect responses are each associated with one or more skills in the domain.

Associating the incorrect response with one or more skills includes specifying a statistical model relating the incorrect response with the associated skills.

Associating the problems with one or more skills includes specifying a statistical model relating a problems with the associated skills.

Authoring the problems includes specifying multiple constituents for at least some of the problems.

Specifying constituents for a problem includes specifying one or more sub-parts that each includes another of the problems.

Specifying constituents for a problem includes specifying one or more hints.

Authoring the problems includes associating constituents of each of at least some of the problems with particular authored incorrect responses to that problem.

Administering the problems to the students includes selecting a subsequent problem according to a result of comparing a received response with the authored responses.

Administering the problems to the students includes selecting a subsequent problem for one of the students according to the maintained assessment for that student.

Administering the problems to the students includes selecting a constituents according to a result of comparing a received response with the authored responses.

Administering the problems to the students includes allowing the student to select a constituent.

Enabling the student to select a constituent includes presenting descriptive information about the constituent to the student, such as a title or a topic, thereby allowing the student to select based on the descriptive information.

Maintaining the assessment of the students includes updating the student's assessment based on a received response from that student that matches all authored incorrect response.

Updating the assessment bases on one or more skills associated with the authored incorrect response.

Updating the student's assessment based on a response time associated with a received response to one of the problems.

Updating the student's assessment based on the number and nature of hints and solutions requested for a problem.

Updating the student's assessment based number of problem or problem sub-parts started but not finished

Combining multiple factors associated with a response to a problem to update a student's assessment.

Optimized the combination of factors for high reliability assessment.

Maintaining the assessment of the students includes applying the statistical model to update the student's assessment based on the skills associated to the problem according to the statistical model.

Applying the statistical model includes applying a Bayesian inference technique to update the student's assessment.

Using the maintained assessments for the students to select from the problems to form an assignment.

Using the maintained assessments for the students to determine a teaching plan for the students.

Determining the teaching plan includes identifying skills in which the students exhibit relatively low proficiency.

Using the maintained assessment for each of one or more of the students to determine a learning style for the student.

Selecting problems for a student according to the determined learning style for the student.

Determining when to present hints to a student according to the determined learning style.

Determining whether to present sub-part problems to a student according to the determined learning style.

Determining a grade for one or more of the students based on the maintained assessment for those students.

Determining an estimated grade on some portion or all of a standard exam in the domain.

Administering the problems to the student includes selecting problems according to an estimated grade for the student on some portion or all of a standard exam in the domain.

Comparing each of the received responses to one or more authored responses includes processing a representation of a mathematical expression.

Correcting errors or ambiguities in a text representation of the expression.

Identifying generic errors in a received response.

Identifying one or more of a sign error and an error in an additive or multiplicative factor.

Identifying generic errors includes identifying extraneous variables in the received response.

Identifying generic errors includes identifying substitution of function specifications.

Breaking a received response into components that are in the corresponding correct response.

Recognize implicit multiplication in a received response (e.g., mg=m*g if both m and g variables in the answer).

Converting a text representation of a received response, (e.g., “mint” to “m_int” indicating a subscript).

Ignore capitalization in a received response (e.g., m replaced by M if only M is in the answer).

Considering alternative orders of evaluation (e.g., 1/2 g is interpreted as 1/(2*g) and checked to see if correct).

Implicitly determining units of numerical quantities (e.g., interpreting sin(10) in degrees, but sin(3.14) in radians).

Cataloging received incorrect responses by frequency

Associating comment to present to a student with specific authored incorrect responses.

Associating a sequence of comments to present to a student on subsequent incorrect responses by the student.

Aspects of the invention can have one or more of the following advantages:

Maintaining a proficiency assessment for skills in the domain provides a basis for selection of appropriate problems on a student-specific basis.

Associating skills with problems, and in particular, associating skills with particular incorrect responses to problems, provides a basis for accurate estimation of a student's proficiency in different skills.

An accurate estimate of proficiency on particular skills provides a basis for a low variance estimate of a student's overall proficiency, and provides a basis for estimating or predicting the student's performance on a standard set of problems or on a standardized exam.

Other features and advantages are evident from the following description and from the claims.

### DESCRIPTION OF DRAWINGS

FIG. 1 is a block diagram of a tutoring system that is structured according to the present invention;

FIG. 2 is a diagram that illustrates a data structure for a problem specification;

FIG. 3 is a diagram that illustrates a data structure for a portion of an answer log; and

FIG. 4 is a flowchart of an answer-processing procedure.

### DESCRIPTION

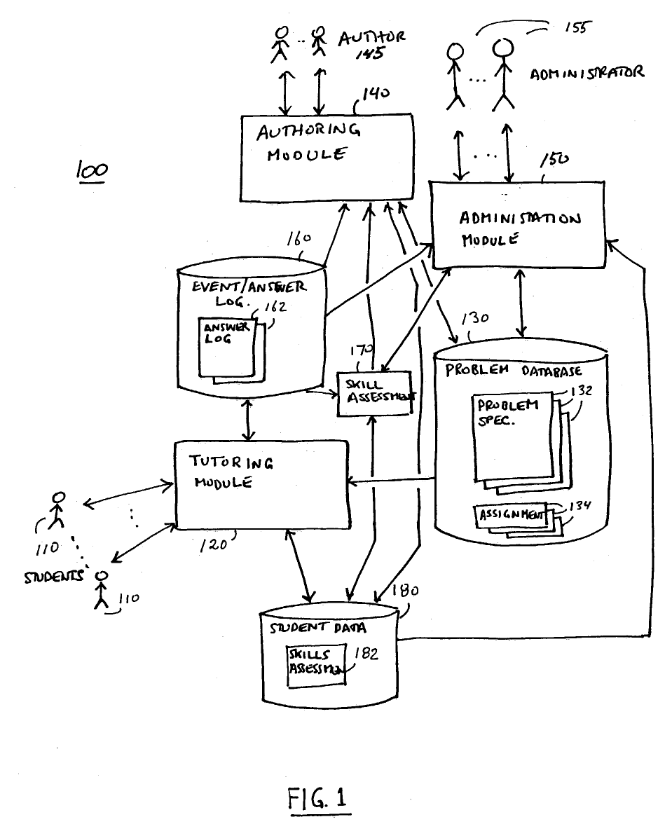

Referring to FIG. 1, a tutoring system 100 interacts with a number of students 110 based on a database of problems 130. A student 110 uses a graphical user interface that is implemented using a “web browser” executing on a client computer that is controlled by a server process executing on a centralized server computer. The domain of the problems can include various subject areas and educational levels. For example, the system has been used experimentally in teaching college-level Newtonian mechanics.

A tutoring module 120 controls the interaction with each student. In a typical session, a student 110 works on an assignment that is made up of a number of problems, and for each problem, the student is presented a number of related parts to the problem. Each part includes a question that the student is to answer. The system presents questions to the students that elicit various types of answers from the students, including free-form text, symbolic mathematical expressions (entered as a text string, keypad entry, or alternatively in a structured form), multiple choice response, subset selection (multiple choice allowing more than one choice), and student-drawn curves or vectors, depending on the type of the question asked.

The system goes beyond presentation of questions and scoring of answers based on whether they are right or wrong. The system conducts a guided dialog with the student that mimics many characteristics of a human dialog with a teacher using a “Socratic” teaching style. This dialog is guided in part by information in problem database 130 and heuristics and statistical algorithms integrated into tutoring module 120. The dialog is also guided by the details of the interaction with the student, including proposed answers submitted by the student to questions posed by the system, other inputs from the student during that problem interaction such as unsolicited requests for “hints,” requests to review previously submitted answers or to view solutions, and the timing of inputs from the student. The dialog is also guided by an ongoing assessment of the student's proficiency at a number of skills that are related to the problem domain and other information known about that student and about other students engaged in similar courses of study.

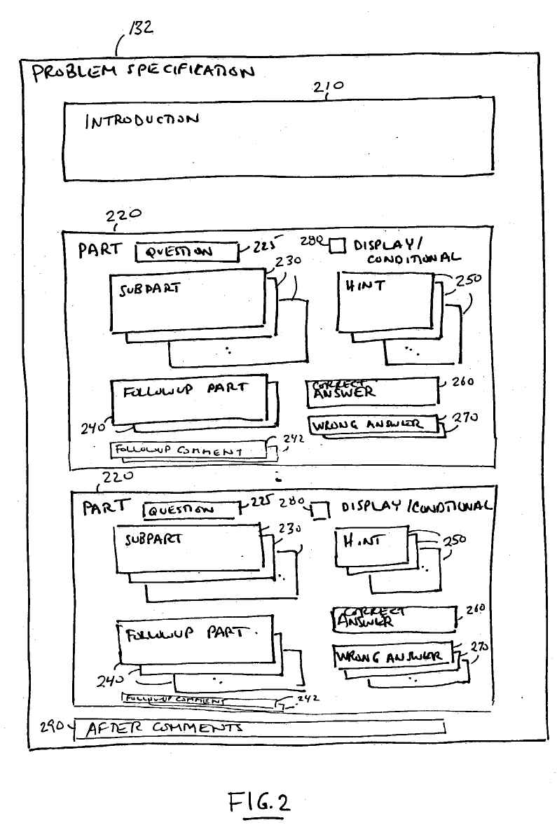

Referring to FIG. 2, a problem specification 132 for a typical problem in problem database 130 is structured to include a number of nested elements. Each problem is stored in problem database 130 using a XML (eXtensible Markup Language) syntax. A typical problem includes an introduction 210 that contains instructional material and also describes the overall problem. For example, in a mechanics problem, introduction 210 typically includes a written description and a diagram of arrangement of elements, such as masses, springs, pulleys, and ramps. Problem specification 132 also includes a number of parts 220. Each part 220 includes a question 225 that the student is expected to answer. All the parts 220 can be displayed along with main part 210 when the student first begins work on the problem. Optionally, some parts 220 can initially be hidden from the student by setting an indicator 280 in those parts. For example, a later part in a problem may give away an earlier answer, and therefore should be hidden from the student until they solve the earlier part. A problem specification 132 call also include an followup” comment 290, which is presented to the student after they have completed a particular part or else all the parts in a problem, for example, providing a summary or an overall explanation of the problem, or a compliment to the student.

For any or all presented but not yet correctly answered parts 220 of a problem, a student may provide a proposed answer that is processed by tutoring module 120 (FIG. 1). The student's proposed answer is first put in a syntactically correct form involving the variables in the solution. If the student's answer matches a correct answer 260 for the part, the tutoring module informs the student that the answer is correct, offering some positive reinforcement. Any part 220 may include a number of follow-up parts 240 or follow-up comments 242 which are presented to the student after the student has correctly answered question 225. The problem is completed when all parts 220 (but not necessarily subparts 230) are completed.

Rather than providing a proposed answer that exactly matches correct answer 260, the student may provide a correct answer that does not match exactly, or may provide an incorrect answer. As a general approach, tutoring module 120 interprets a proposed answer to determine if it is mathematically or logically equivalent to correct answer(s) 260, and if the proposed answer is not equivalent to the correct one, determines or guesses at the nature of the student's error. For example, the program checks to see if the units for a physical quantity or for angles are incorrect, or examines to see the student has made an error which is known to be common for students using the particular system of entering the expression for the answer (that is an error in entry of the answer as opposed to an error in the students determination of the answer). The tutoring module then uses the nature of the student's error to control the dialog with the student. The dialog in response to an incorrect answer can include presenting a hint 250 to the student and soliciting another proposed answer. Hints can take a variety of forms. Examples include rhetorical questions, and suggestions such as to check the sign of various terms in an algebraic expression. Another type of “hint” in response to a particular incorrect answer is a subpart 230 relevant to the student's mistake, for example, to guide the student through one or more steps that will yield the procedure which will enable him to answer the overall part 220. Each subpart 230 has the same structure as a part 220, and subparts can be nested to many levels.

A specification of a part 220 can identify particular wrong answers 270, and associate those wrong answers with corresponding specific hints 250 or subparts 230 that tutoring module 120 presents as part of its dialog with the student in response to an answer that matched a particular wrong answer 270. By establishing such an association of wrong answers with specific hints and subparts, an author of a problem can program the nature of the dialog that the tutoring module will have with a student.

The program analyzes the responses of many students to the problems, informing the teacher or problem author about all aspects of this interaction. For example, the students' incorrect responses can be presented to the author with data allowing the author to respond to future students who give any specific set of them, especially the more frequent wrong responses, with comments or with specific parts or problems as described above. In this manner, the program's response to students are similar to an intelligent tutor system except that instead of relying solely on an AI-based model of the student's thinking, the model of the student's thinking is inferred by the problem author from the responses displayed, from his teaching experience, by asking future students how they obtained that response, or by educational research undertaken with the program or in other ways.

A student who is unable to provide an answer, or seeks reassurance on the way to the answer, can request that tutoring module 120 provide one or more sequential hints, for example, by pressing a “hint” button on the display. Depending on problem specification 132, such a request for a hint may yield a statement or a subpart that asks a question. These appear within the overall problem display. Alternatively at the discretion of the problem author, the student is able to request a “hint list” of available hints, each identified by a subject title, from which the student selects one or more to view. This feature, like the general feature that a student can work the problems in an assignment or the parts of an assignment in any order is specifically to enable to student to remain in charge of his own learning, and what to learn next. In response to a student's request for a hint, the system provides a prewritten hint or part. These are distinguished from the “generic” hints based on the form or value of the correct answer. For example, a hint which provides the student a list of all the variables or functions that should appear in a symbolic answer, or a hint that gives a range of numeric values within which a numeric answer falls.

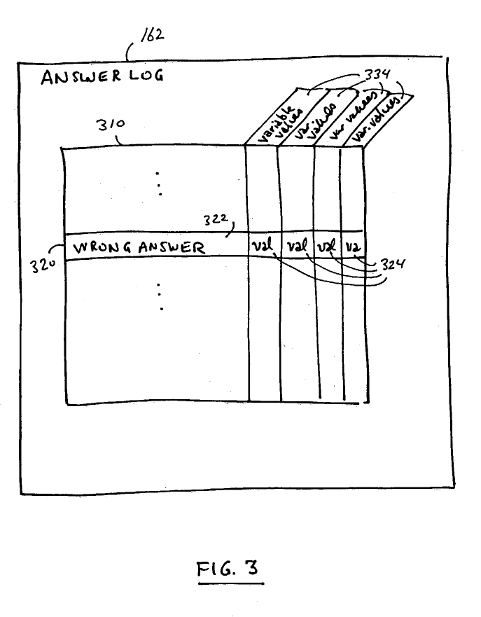

If none of the typical mistakes appears to have been made, the tutoring module 120 then compares the student's answer to specific wrong answers 270. This comparison is performed numerically. The student's symbolic answer is evaluated for each of one or more sets of variable values yielding a numeric value corresponding to each set. Referring to FIG. 3, answer log 162 (FIG. 1) includes a table 130 that is associated with a particular problem which includes a number of records 320, each associated with a different wrong answer 322 for that problem. For each wrong answer, a numeric evaluation of that wrong answer 324 is stored corresponding to each particular choice of numeric values.

In addition to comparison of a student's answer with specific wrong answers 270, the tutoring module also uses generic techniques to determine the nature of the student's error and to act on that determination by providing a corresponding hint 250 or subpart 230.

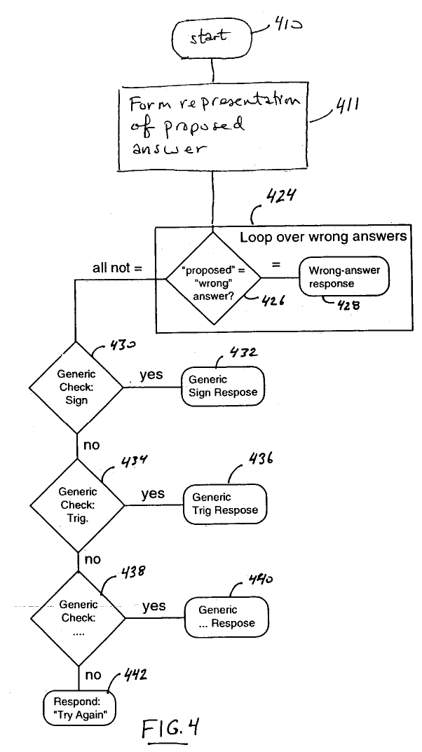

Referring to FIG. 4, a procedure for processing a student's proposed answer involves a series of steps beginning at a start 410. As described above, this comparison is performed numerically for symbolic answers.

The system accepts various forms of answers for questions. Therefore, determining whether a student's proposed answer is correct or matches a particular incorrect answer involves a number of processing steps performed by the answer analyzer especially for free response answer types (see FIG. 4). The answer analyzer first interprets the string provided by the student to form a representation of the expression that encodes the meaning or structure of the expression (step 411). The proposed answer is checked for misspellings, which can include errors in formatting, syntax, and capitalization, and missing mathematical symbols. A best guess is then made of what the student intended based on the variables, functions, words, and other characteristics of the correct solution or solutions. Upon completion of the processing, as well as at various intermediate stages within the processing, the proposed answer is compared to the correct answer (step 412). If these answers match, the system declares that the proposed answer is correct (step 414). The procedure then continues with a loop over the specific wrong answers (steps 424). The student-proposed answer is compared with each author-entered wrong answer (step 426) and if the proposed answer matches the wrong answer, the system declares a match to that wrong answer and provides a response associated with that wrong answer (step 428). If none of the wrong answers match, the system performs a series of checks for generic classes of errors. One generic class of errors is associated with common errors made in the particular answer entering and formatting system used for that answer type. Another class of common errors is associated with the knowledge domain of the answer type, such as using degrees instead of radians, mixing up standard functions or procedures, entering physical quantities in the wrong units, common non-trivial misspellings of words, and common errors in various branches of mathematics such as trigonometry, algebra, and calculus. Algorithms for both the interpretation phase and the various generic answer checks are based on a combination of human judgment encoded in the software, and the author's judgment encoded in the questions which may be based on the author's study of large numbers of previously logged wrong answers to verify that the corrections used would correct only the desired wrong answers without generating incorrect grading for correct answers. As an example of these steps, consider the submission of a symbolic answer as a text string. For example if the student types “m2 g*−h”, the answer analyzer interprets this as “m2*g*(−h)” if “m2”, “g”, and “h” but not “m” were variables in the correct answer, but as “2*M*g*(−h)” if “M” but not “m2” or “m” was a correct variable. Functions and greek letters are recognized at this point so that sinepsilon becomes sin(ε). If the student string does not contain all of the variables of any of the correct answers supplied by the author, the student is appropriately informed of the deficiency. If extra variables appear in the student answer, the student is so informed, and is additionally notified if these extra variables do not affect the value of the answer (e.g., if they cancel out of the expression). If the variables match those in any one of the correct answers, the answer analyzer compares that answer against the correct answer(s) 260. If they do not match, the student is informed about the missing or extra variables. Students are informed if they have extra functions, or not enough functions. If the student answer, now with the correct structure, functions, and variables does not equal the correct answer, the answer analyzer now compares the proposed answer with each of the specific wrong answers. If the student's answer matches a particular wrong answer, then the answer analyzer proceeds based on this match, for example, by providing a specific hint or a specific new part that is associated with the matching wrong answer. A specific hint might be “you should apply the parallel axis theorem to find I of the barbell”.

If none of the specific wrong answers matches the proposed answer, this answer is first checked by the generic wrong answer algorithms. For a symbolic answer a generic formatting error might be to type 1/a*b instead of 1/(a*b). The corresponding algorithm would add parentheses appropriately to variables after the “/” sign and compare the resulting revised proposed answer with the correct answer and the specific wrong answers. Algorithms for domain include the replacement of an integer number in the argument of a trig function by PI/180 times that number, so that sin(A+45) would be interpreted as sin(A+PI/4). This would grade an answer given in degrees in radians. A common mistake is in the sign of one term in the proposed answer. The algorithm for this changes each sign in the student's proposed answer to the same sign (say plus), and this is compared to the correct answer with its signs similarly changed. If the answers with the signs changed match in a non-trivial way for different sets of randomly generated variables (e.g. 0=0 would be trivial), a generic response related to sign errors is provided by the answer analyzer to the student (step 432), Such as “check your signs.” A similar form of generic check is performed for trigonometric errors (step 434). In this check, each trigonometric function is replaced by the same function (say sine) and the answers are compared. For example, a student's error of interchanging “sine” and “cosine” will be detected in this way. If this generic error-processing step matches the proposed and correct answers, the system provides the student with a hint to check the trigonometric functions (step 436). This generic processing is repeated for a number of additional tests (step 438) each with its corresponding generic hint, and each with the possibility that in addition to displaying the generic hint, the proposed answer may be graded correct if the student's error is determined to be minor (step 440). These additional tests can include checking whether the proposed answer is off by an additive term or a multiplicative scale factor from the correct answer, has a term which is off by a factor, has just one of several terms incorrect, incorrectly associates terms in a symbolic expression (e.g., a times (b+c) versus (a times b) plus c), matches non-trivially in the case that one of the variables is set to zero (so the student can be told that the dependence on this variable is incorrect) or if one of the variables has a special value, has incorrect dimensions or units, scales correctly when one of the variables is changed by a constant factor, would match the correct answer if one of the variables were replaced by any other of the variables, is only slightly greater or smaller than the allowed variation of the correct answer. The various algorithmic checks can optionally be performed in combination with each other, or with specific wrong answers (e.g. even if you check your signs, you should apply the parallel axis theorem to determine I of the barbell). Also, the second time a generic or specific wrong answer is submitted, the program optionally responds differently and more specifically than for the first occurance. Finally, if the system cannot match a student's proposed answer with any of the known wrong answers or determine that a generic error was made, the system asks the student to try again (step 442).

While the comparisons of symbolic answers described above are made using programs that handle symbolic variables, alternatively or in addition the system operates numerically by evaluating the student's proposed answer (once its structure is correct) and the alternate author-provided correct answers with the same random number for each of the variables, then comparing the two resulting numbers. If these match within a certain fractional error plus additive error, which may depend on the nature of the expressions, and if this matching is repeated for a prespecified number of times, the expressions are declared to match. This procedure can be used for evaluating generic and specific wrong answers. If the original evaluation of the proposed answer is cataloged along with the response which it generated (i.e. from the generic algorithms or specific wrong answers), future proposed answers need be evaluated using the same random variables, and the appropriate response quickly determined by finding the matching cataloged evaluation.

As the student works on a problem, the student can review his previous answers. For each answer, the student can review the systems's interpretation of the answer, the numerical evaluations for particular variable values, and hints, or generic or specific wrong answer responses that were presented. In certain circumstances, the system provides the review to the student without the student requesting it, for example, if the student proposes the same wrong answer multiple times. Different preset criterion can be used by the system to determine when to present such a review, for example, based on the student's skill profile or his recent use patterns.

Referring back to FIG. 1, the system maintains student data 180 For each student. Tutoring module 120 logs each student interaction event, such as a proposed answer or a request for a hint, in each student interaction in event/answer log 160 along with its time. The log includes a skills assessment 182 generated by module 170 that processes the log of each students' events and extracts variables from which it updates their skill assessment 182. This monitoring and skill assessment is an ongoing process during interactions with the students. Examples of skills include facility with conceptual topics, foundational topics for that domain, topics that would be part of the syllabus of things to be taught, and can include concepts, declarative knowledge, and procedural knowledge. Examples of topics might include concepts such as Newton's laws of force or potential energy, foundational skills, such as ability to manipulate vector components, general skills such as correct use of dimensions and units and specific skills such as ability to apply conservation of momentum to problems involving one dimensional inelastic collisions.

Highly reliable and detailed assessment can be obtained from analysis of the data log of each student. Since the system's goal is to tutor each student through to the correct answer, and over 90% of the students ultimately correctly answer the majority of questions in the current experimental version for college students, this assessment is based on all aspects of the student's interaction with the system, not solely on the correctness of the ultimate answers. Aspects of this interaction that negatively affect the system's assessment of the student's skills include among others the slowness of response and slowness of getting the correct answer, the number and nature of the hints requested by the student, the number and nature of wrong answers, the number of solutions requested, the total number of problems not attempted, and the number and fraction of attempted problems not completed. Other relevant variables are the percentage of correct answers obtained on the first or on the second or on both submissions, the time the student takes to make a first response, and the quickness of a student's response to a particular wrong answer comment. Algorithms based on these variables are used to give credit to the student, and to assess his/her overall competence.

The large amount of data collected by the tutor may be processed to find each student's skills on many different topics. To do this, the author of a problem can associate each part and subpart of each problem, and optionally particular wrong answers with skill on a particular topic or topics. In this way the author implicitly constructs a data base of which topics are involved in each problem, and which topics are foundational skills of other topics. A standard group of students may then be used as a reference group to calibrate the difficulty of each subpart or usefulness of each hint. If a student correctly answers a part, this indicates that he probably possesses at least the level of skill equal to the difficulty of each subpart of that problem. If the student submits a wrong answer to a part that has been specifically linked with a particular topic, the system appropriately reduces the student's skill rating on that topic. If the student submits a wrong answer not linked with any topic, the program uses probabilistic algorithms (e.g. based on Bayesian analysis) to assign the lack of skill to each of the topics required on the hints for that part, based on the prior knowledge of the student on the topic of each of the hints or subparts. As tutoring module 120 interacts with each student, it thereby updates that student's skill assessment on each of the topics involved in solving each particular problem.

The student's skill profile is used for a number of different purposes. One purpose is to inform the student or his teacher where strengths or weaknesses lie. Alternatively, the profile guides and monitors the progress in a series of problems selected and presented to the student to remediate the student's deficiencies. Another is to predict the student's performance on a standard exam in which they might have a limited amount of time to answer a set of questions. A multiple regression or other statistical analysis based approach is used to associate the skill profile data for past students and their known grade on that examination. That association is then used to predict performance of future students on that particular type of standard exam.

Another use of the student's skill profile is during the interaction with the student. For example, when the student provides an incorrect answer to a part, the tutoring module provides hints based on an assessment of the nature of the student's error, and that assessment is based, for example statistically, on the student's skill profile and the known difficulty of each of the hints and parts necessary to reach the correct answer.

In another use of the skill profile, the system adapts to students who are not proficient at particular skills. For example, rather than waiting for an incorrect response from a student who is not proficient at a required skill for a problem, the system preemptively presents subparts that build up to the correct problem or presents remedial problems on that topic to the student.

The system can dynamically generate a multiple-choice question rather than use a free response form. This feature is optionally selected by the author of an assignment, who may propose some of the distractors, or can be automatically selected by the system, for example, if a student is having difficulty with a problem. In one example of this technique, the most frequent wrong answers are used as distractors from the correct answer. The correct answer and the four most frequent incorrect answers are presented in a random order in a five-choice multiple-choice question. The wrong answers can also be chosen to adjust the difficulty of the problem. For example, choosing less frequently given wrong answers as “distractors” may yield an easier question than if the most frequent wrong answers were chosen. The choice of possible answers can also be tailored to the particular student. For example, the choice of distractor answers can be based on the student's skill profile by choosing wrong answers that are associated with skills that the student is deficient in.

Yet another use of the skill profile is in selection of the particular problems that are presented to a student in a particular assignment or lesson. For example, the problems are chosen in turn in a feedback arrangement in which the updated skill profile after each problem is used to select the next problem to be presented to the student. One such method of choosing a next problem is to focus on the student's weaknesses by presenting problems that match deficiencies in the student's profile as well as the topic of the particular assignment.

The tutoring module performs a grading of a student's performance based on a number of factors. The grading of the student's work uses a partial-credit approach that is based correct answers provided by the student and factors in the hints that were requested, or equivalently, the available hints that were not used. If a question is presented in multiple choice form, a penalty for wrong answers is used to avoid rewarding guessing. The grades of each student are presented to the student and the teacher in a gradebook which also computes various averages, class standings, and standard deviations.

Referring back to FIG. 1, tutoring system 100 includes an authoring module 140 that provides an interface to authors 145 and an administration module 150 for administrators 155. The authoring module provides a mechanism for an author of a question to initially specify problems and ancillary information about them that are stored in problem database 130. After those problems have been asked of a number of students, the authoring module contains problem views to allow that author or another author to modify the question. For example, the wrong answers are displayed in decreasing order of the number of students whose answer evaluates equal to those displayed facilitating the generation of appropriate specific wrong answer responses as described above. Color bars display the fraction of students getting each part or subpart correct and the numbers of correct and incorrect answers, hints and solutions requested for each problem, part, and subpart. This shows where additional hints or subparts or instructional material should be added to the problem. Student questions asked to the on-line teaching assistant and student comments are displayed for each problem to enable teachers to apprehend consistent difficulties of the students enabling the problems to be modified accordingly, or FAQ's to be added within the problem structure. Access to wrong answers, recent student questions and comments, and color bars that compare the current class with previous classes are all provided to teachers and staff members to allow them to discover difficulties of their class, which they may address in lecture, to provide “Just in Time Teaching”. The class' overall skill profile can also be displayed for this purpose. An assignment module enables a teacher to assemble questions into an assignment, for instance, to specifically address a class's overall skill profile.

An assignment is made up of a series of problems which may be assigned for credit or as practice, and optionally must be completed in order. These problems are selected from the problem data base, which can be displayed by topic, subtopic, problem difficulty, number of students who have done that problem, or more generally in increasing or decreasing order for any of the information displayed about the problem including among other things student rating of its difficulty, the amount learned from it, the median or other statistical measure of the time students require to work the problem as determined by an algorithm that analyzes previous student data, the number of wrong answer responses, the number of student comments of various types, and a reliability algorithm which combines all this information together with information about the number and timing of checks which various authors have made of the problem. An assignment or lesson can include a larger set of problems that are chosen dynamically based on a student's performance.

When authors of the system have associated particular skills with various problems, the function of assembling an assignment is aided by an interface that identifies potential problems based on the skills the assignment author wants to concentrate on. Problems are also associated with particular sections of textbooks that may be used in live instruction of the students, and the assignment author chooses problems that are associated with a particular section of the textbook.

The assignment author can modify the display of the problems, for example, by requiring that subparts be presented even if the student does not require hints, or by having the questions asked in multiple-choice rather than free-format form, or by instructing the student to “hand in” a written version of the solution to the problem while simultaneously disabling certain features of the system (e.g. so that the student can receive no solutions or no hints or no feedback on answers to parts initially displayed).

A function supported by administration module 150 relates to teaching or study of particular groups of students. For example, an instructor interacts with the module to identify the students in the group (e.g., a section of a college course), and to select assignments for those students. These assignments can be identified as being for practice, or counting towards the student's grade. The module also provides an interface to view information about the students in each group, such as the problems they have worked on, their grades, and their skills assessments, and their predicted performance on standardized exams. This feature is particularly useful to study whether the performance of group one on a problem presented to two equally skillful groups is influenced by instructional material or a previous problem that is administered only to group one. This allows determination of the educational efficacy of individual problems or exercises in the database, which information can be displayed in the library.

Problem database 130 includes information about problems such as the common wrong answers. This information can be broken down by different teaching levels. For example, the sample problem may be available for a college level course as well as for a high-school advanced placement course. The information about the problem allows an assignment tailored to the particular teaching level.

Alternative versions of the system can include subsets of the features described above. In addition, the tutoring system can include one or more of the following additional features.

The students' symbolic answer can be processed into a standard or canonical form prior to comparison with the stored correct and wrong answers. For example, terms in an algebraic expression can be rearranged by alphabetizing the order of variables in each term and then recursively alphabetizing the terms. The rearranged string representation of the answer is then compared to similarly processed correct and incorrect answers in order to identify whether the two are equivalent.

The student's symbolic answer can also be compared to the correct and wrong answers using a symbolic processing system. For example, Maple or Mathematica is used to determine whether the symbolic expressions are equivalent. In order to reduce the amount of computation required by such symbolic comparison, the system optionally first compares the standard string representations of the expressions, and the numerical evaluations of the expressions for a number of different sets of variable values, and only if the two are numerically equal, but have different string representations, are the expressions compared symbolically.

Additional types of analysis of a student's answers can also be performed. For example, in the case of proposed answers in the form of symbolic expressions, these expressions can be evaluated for particular variable values. For example, boundary conditions can be checked. A symbolic expression or a submitted graph of a function can be processed, for example, taking its derivative or a limit of a variable value as it reaches zero or some particular value, and the resulting expression can be compared to the correct answer similarly processed. In this way, the comparison is not only with specific wrong answers, but essentially with classes of wrong answers that share similar characteristics, and the dialog can be pre-programmed by the author to respond to such classes of errors. Similarly, words or phrases may be checked for spelling or grammatical equivalence using phonetic methods or lists of frequently misspelled words.

In some alternative version of the system, the parts and subparts are presented in different orders in different student dialogs. The tutoring system then adapts the later questions to take into account what has been disclosed to the student in earlier parts. One approach to this adaptation is to enforce a partial ordering on the subparts that can be presented to the student. Another approach is to modify the questions in each subpart based on the subparts that have already been answered by the student.

Tutoring module 120 can also select one or more hints from a larger set of available hints in response to a student's request that are specifically tailored to that student, or to the prior dialog between the student and the system. For example, the selection of hints can be based on that student's skill profile by presenting hints related to topics that the student is less proficient in.

The updating of the student's skill profile can be based on statistical inference. In such an approach, the current estimate of the student's skill profile, and a probabilistic model of the skills required to answer a particular question are combined with the student's logged interactions to update the student's skill profile. The current version of the system determines the difficulty of each problem and problem part by a weighting formula based on the number of wrong answers, hints requested, solutions requested. Alternate versions additionally incorporating metrics such as the skill profile of the students, timing data, specific wrong answers, and generic wrong could provide a much more detailed and informative description of each part's difficulty

Alternate versions of the system can have different methods of assessment and grading. For example administering tests before and after a session or a course using the tutor program enables an assessment of the amount learned from the tutor for each student. Statistical analysis of this information allows development of algorithms that assess how much the student is learning. Such analysis can be refined by examining the rate of increase of the skill profile. This makes it possible to grade students on the basis of the current state of their knowledge or the rate of increase of their knowledge rather than by a system that penalizes for mistakes made before corrective learning occurred. Assessment may also have the objective of determining each student's particular overall approach or learning style, which in turn can inform the student on how to optimize his learning strategy and can be used by the program to select problems to enable that student to learn optimally (e.g. a few “hard” problems vs. more “easy” problems).

It is to be understood that the foregoing description is intended to illustrate and not to limit the scope of the invention.

What is claimed is:

1. A method for computer aided tutoring comprising:
authoring a plurality of problems in a domain, including
for each of at least some of the problems authoring a correct response and one or more incorrect responses to the problem, and
for each of at least some of the problems, associating the problem with one or more skills in the domain;
administering one or more of the problems to one or more students, including
presenting the problems to the students,
receiving responses to the problems from the students, and
comparing each of the received responses to one or more authored responses for the problem, including for at least some of the problems comparing the receiving response to one or more incorrect responses authored for the problem; and
maintaining an assessment of each of the students that includes a proficiency assessment for one or more skills in the domain, including
updating a student's assessment based on a received response from that student to one of the problems and one or more skills associated with that problem.

2. The method of claim 1 wherein associating the problems with one or more skills includes for each of at least some of the authored incorrect responses to problems, associating those incorrect responses with one or more skills in the domain.

3. The method of claim 2 wherein associating the incorrect response with one or more skills includes specifying a statistical model relating the incorrect response with the associated skills.

4. The method of claim 1 wherein associating the problems with one or more skills includes specifying a statistical model relating a problems with the associated skills.

5. The method of claim 1 wherein authoring the problems further includes specifying multiple constituents for at least some of the problems.

6. The method of claim 5 wherein specifying the constituents for a problem includes specifying one or more sub-parts that each includes another of the problems.

7. The method of claim 5 wherein specifying the constituents for a problem includes specifying one or more hints.

8. The method of claim 5 wherein authoring the problems further includes associating the constituents of each of at least some of the problems with particular authored incorrect responses to that problem.

9. The method of claim 1 wherein administering the problems to the students further includes selecting a subsequent problem according to a result of comparing a received response with the authored responses.

10. The method of claim 1 wherein administering the problems to the students further includes selecting a subsequent problem for one of the students according to the maintained assessment for that student.

11. The method of claim 1 wherein authoring the problems further includes specifying multiple constituents for at least some of the problems, and wherein administering the problems to the students further includes selecting a constituent according to a result of comparing a received response with the authored responses.

12. The method of claim 1 wherein authoring the problems further includes specifying multiple constituents for at least some of the problems, and wherein administering the problems to the students includes enabling the student to select a constituent.

13. The method of claim 12 wherein enabling the student to select a constituent includes presenting descriptive information about the constituent to the student and enabling the student to select based on the descriptive information.

14. The method of claim 1 wherein maintaining the assessment of the students further includes updating the student's assessment based on a received response from that student that matches an authored incorrect response.

15. The method of claim 14 wherein updating the student's assessment based on the received response from that student that matches the authored incorrect response includes updating the assessment bases on one or more skills associated with the authored incorrect response.

16. The method of claim 1 wherein maintaining the assessment of the students further includes updating the student's assessment based on a response time associated with a received response to one of the problems.

17. The method of claim 1 wherein associating the problems with one or more skills includes specifying a statistical model relating a problems with the associated skills, and wherein maintaining the assessment of the students includes applying the statistical model to update the student's assessment based on the skills associated to the problem according to the statistical model.

18. The method of claim 17 wherein applying the statistical model includes applying a Bayesian inference technique to update the student's assessment.

19. The method of claim 1 further comprising using the maintained assessments for the students to select from the problems to form an assignment.

20. The method of claim 1 further comprising using the maintained assessments for the students to determine a teaching plan for the students.

21. The method of claim 20 wherein determining the teaching plan includes identifying skills in which the students exhibit relatively low proficiency.

22. The method of claim 1 further comprising using the maintained assessment for each of one or more of the students to determine a learning style for the student.

23. The method of claim 22 wherein administering the problems includes selecting problems for a student according to the determined learning style for the student.

24. The method of claim 1 further comprising determining a grade for one or more of the students based on the maintained assessment for those students.

25. The method of claim 24 wherein determining the grade includes determining an estimated grade on some portion or all of a standard exam in the domain.

26. The method of claim 24 wherein administering the problems to the student includes selecting problems according to the determined grade for the student.

27. The method of claim 1 wherein comparing each of the received responses to one or more authored responses includes processing a representation of a mathematical expression.

28. The method of claim 27 wherein processing the representation of the mathematical expression includes correcting errors or ambiguities in a text representation of the expression.

29. The method of claim 1 wherein administering the problems includes identifying generic errors in a received response.

30. The method of claim 29 wherein identifying generic errors includes identifying one or more of a sign error and an error in an additive or multiplicative factor.

31. The method of claim 29 wherein identifying generic errors includes identifying extraneous variables in the received response.

32. The method of claim 29 wherein identifying generic errors includes identifying substitution of function specifications.

33. Software stored on a computer-readable medium comprising instructions for causing a computer system to perform functions comprising:
providing an authoring interface for specifying a plurality of problems in a domain, including
for each of at least some of the problems accepting a correct response and one or more incorrect responses to the problem, and
for each of at least some of the problems, associating the problem with one or more skills in the domain;
administering one or more of the problems to one or more students, including
presenting the problems to the students,
receiving responses to the problems from the students, and
comparing each of the received responses to one or more authored responses for the problem, including for at least some of the problems comparing the receiving response to one or more incorrect responses authored for the problem; and
maintaining an assessment of each of the students that includes a proficiency assessment for one or more skills in the domain, including
updating a student's assessment based on a received response from that student to one of the problems and one or more skills associated with that problem.
